(19) United States
(12) Patent Application Publication
(10) Pub. No.: US 2021/0404513 A1
(43) Pub. Date: Dec. 30, 2021

(54) Locking Ball Joint

(71) Applicant: Vann Stone Faison, Seattle, WA (US)

(72) Inventor: Vann Stone Faison, Seattle, WA (US)

(21) Appl. No.: 16/914,377

(22) Filed: Jun. 28, 2020

(51) Int. Cl. F16C 11/10; F16C 11/06

(52) U.S. Cl. CPC F16C 11/106; F16C 11/0604; F16C 11/0623

(57) ABSTRACT

The present application discloses a ball joint that consists of a ball that may expand or contract, and a coupling that may expand or contract in order to lock the ball joint and prevent rotational movement. In the basic structure, the ball and the coupling may have an internal passageway that allows for a pressurized or depressurized member to pass through. The ball joint allows for a fixed condition that resists rotation under one pressure condition, and various degrees of rotation under a different pressure condition.

### TECHNICAL FIELD

The present disclosure relates generally to the field of mechanical joints. This disclosure more specifically relates to ball joint that can become locked in position due to a pressure change.

### BACKGROUND

The intended purpose of this section is to provide context to the invention that is stated in the claims. The description herein may include concepts that have the ability to be performed, but have not necessarily been previously performed or conceptualized.

Ball joints often connect two components and allow multi-axial degree of rotation. They maintain rotational movement throughout their use. This has the disadvantage of making the positioning of the jointed components unintentionally altered after the jointed components have been positioned. This prevents one of the components from becoming fixed in relation to the other component.

Some ball joints may have an additional threaded part that a user can spin to lock the ball in place. This requires that the user directly physically alters the joint. The joint may become fixed due to an external user action at the joint.

Although some ball joints may allow for components to connect together, and provide a degree of movement relative from one component to the other; these ball joints do not provide the benefit of locking the position of one component in relation to the position of the other component.

Although some ball joints may lock the position of one component in relation to the position of another component, these ball joints require a direct physical fastening at the ball joint by the user.

### SUMMARY

The locking ball joint is capable of maintaining various directions of rotation under one condition, while becoming locked in place under another condition. These conditions may be internal or external pressure differences to the joint and may change depending on the application of the ball joint. The pressures may be positive pressure within or around the joint, or may be negative pressure within or around the joint.

One exemplary embodiment of the disclosure relates to a locking ball joint that uses pressure to lock itself into a fixed position. The basic structure may comprise a coupling and a ball joint. The ball joint may have reliefs that allow for both the ball joint to have both the formal rigidity to act as a ball joint with various axis of rotation, while also having the ability to expand the ball to the coupling from an internal pressure within the ball joint. The ball joint may also lock as a result of a contraction of the coupling to the ball as a result of pressure exhibited onto the ball joint.

In another exemplary embodiment, the ball joint may have a flexible fluid tube that passes through the joint. The flexible fluid tube may expand within the ball and may push ball outwards and against the coupling. The expansion of the fluid tube applying pressure to the inside of the joint may be what allows for the ball joint to become locked.

In another exemplary embodiment, the locking ball joint includes an internal component that locks the ball joint as a function of electrical stimulus. This may occur due to the expansion or contraction of an actuator, servo motor or electroactive composite material applying pressure within the joint.

The locking ball joint coupling may have reliefs that allow for both the formal permanence to act as a coupling for the ball, while also having the ability to contract inwards and onto the ball. The locking ball joint coupling may contract due to a vacuum or negative pressure. There may be a tube surrounding the ball joint that contracts to the ball joint when vacuum pressure present. The coupling may contract around the ball as a reaction to the tube vacuum pressure that is imposed on the outside surface of the coupling.

In another embodiment, the locking ball joint coupling may be surrounded by concentrically aligned tubes with space between them that contain positive or negative pressure. The outermost tube may not exhibit expansion or compression under pressure while the inside tube does. The inside tube may grow towards or shrink from the coupling exhibiting a pressure change to lock the coupling to the ball, or to lock the ball to the coupling.

In another exemplary embodiment, the locking ball joint coupling includes an external component that locks the ball joint as a function of electrical stimulus. This may occur due to the expansion or contraction of an actuator, servo motor or electroactive composite material applying pressure around the joint or within the coupling.

Further embodiments and advantages of this current disclosure may be achievable due to the consideration of these Claims, this Detailed Description and these Drawings. It should be understood that this Summary and the Detailed Description of the current disclosure are intended to be exemplary and are meant to further explain while not limiting the scope of the current disclosure.

### BRIEF DESCRIPTION OF DRAWINGS

FIG. 1 is an unlabeled perspective view of the Locking Ball Joint.

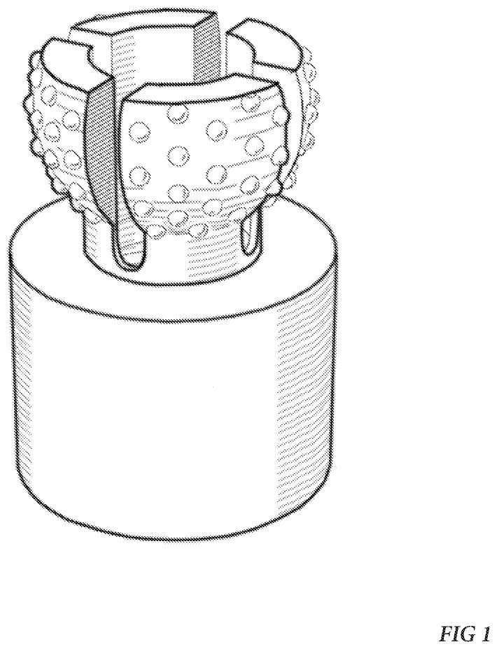

FIG. 2 is a labeled perspective view of the Locking Ball Joint.

FIG. 3 is a plan view of the Locking Ball Joint.

FIG. 4 is a cross-sectional view of the inside of the locking ball joint.

FIG. 5 is a cross-sectional view of the inside of the locking ball joint.

FIG. 6 is a cross-sectional view of the inside of the locking ball joint.

FIG. 7 is a cross-sectional view of the inside of the locking ball joint.

FIG. 8 is a cross-sectional view of the inside of the locking ball joint.

### DETAILED DESCRIPTION OF THE DRAWINGS

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The present application discloses a ball joint that uses pressure to lock itself into a fixed position. Certain uses may require that the ball joint maintains a fixed position at particular locations, or at particular orientations.

For example, a camera may be on a stand and need adjustment, a locking ball joint will allow the user to quickly reposition the camera and lock it into place. A locking ball joint that uses pressure to create a mechanically fixed ball joint may be advantageous to a ball joint that does not lock in place due to the speed and simultaneity of locking a series of adjoined ball joints with one action. With the present invention, a photographer may adjust the camera and push a button that adjusts a fluid pressure, electrical stimulus, or pushes an expanding member into the ball joint for a camera repositioning. This would allow for the photographer to quickly adjust the camera for the next shot.

Similarly, a police officer may find it advantageous to utilize a flashlight that allows for various angles of direction for the light to be positioned. The light may get unintentionally reconfigured during their activities. Having a ball joint that locks in place quickly would allow for them to set the light to a variety of positions and quickly change the light position to various angles.

The present application discloses a ball joint that uses pressure or vacuum, to lock itself into a fixed position. With a change in pressure, the ball joint may be free to rotate. The ball joint pressure change may be a result of fluid hydraulic, fluid pneumatic, electronic stimulation, or mechanical alteration from an internal or external source.

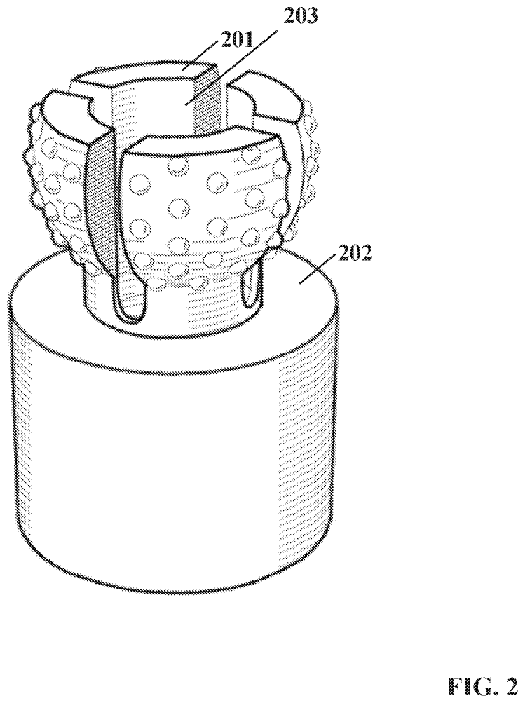

The basic structure may comprise an internal cavity, shown on FIG. 2 as 203, which contains the fluid or electronic actuator and a ball 201, which is at least partially spherical in nature to allow for rotation within a coupling 202. In some embodiments, the ball joint may be locked and/or unlocked into place at a portion of or the entirety of the ball joint by pressurizing or depressurizing at the component served by the ball joint. In other embodiments, the change of pressure may be initiated from a point along the body of the ball joint.

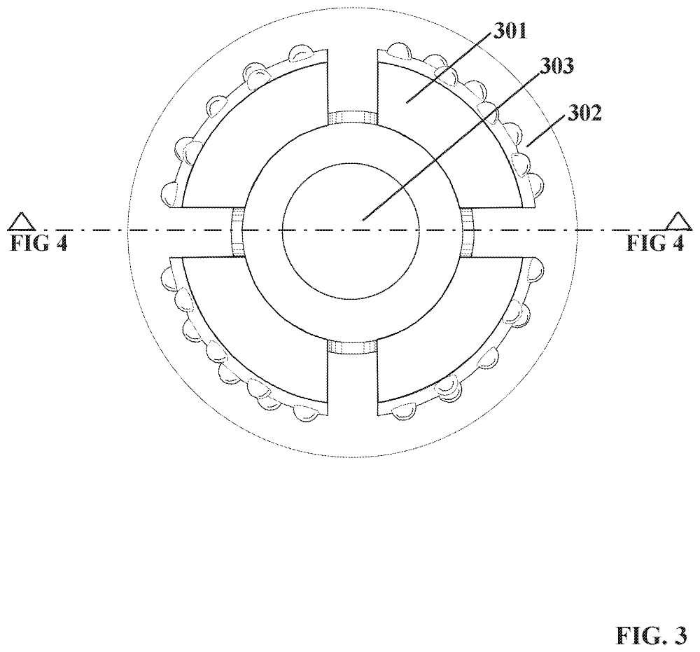

An exemplary plan view of the locking ball joint, FIG. 3 shows the ball joint 301 surrounding an internal cavity 303. This internal cavity 303 may contain a fluid tube that can expand and contract depending on the fluid pressure applied. Component 302, may be indicative of a component of which the ball joint is fastened to, or joined with. This component may contain a coupling to the ball, or the component 302 may be any of a wide possibilities of objects for which the ball joint serves.

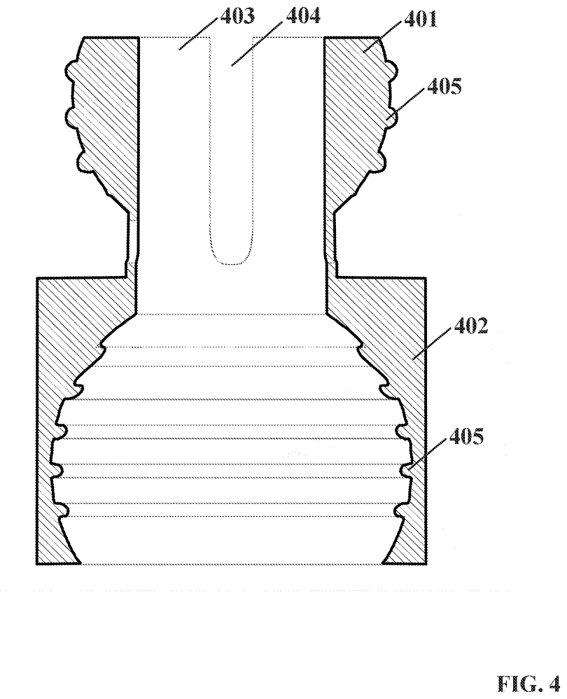

The Ball Joint may happen as a stand alone joint, or as a chain of ball joints. The cross sectional view in FIG. 4 shows the ball 405, attached to the coupling 402. Expansion gap 404 is positioned on the ball in this exemplary embodiment and is intended to allow the ball to expand or contract from its exemplified condition. Coupling 402 may have surface variations that allow for the ball joint to lock in place. Grips 405, may be grooves or ridges and may be positioned along the ball or the coupling. Grips 405, may be grooves or ridges and may be positioned on both or either the ball and the coupling. Grips 405, may also be indicative of a smooth or textured material that allows the ball joint to lock in place. For example, grips 405 may have rubber contact surfaces, and when pressed together with vacuum or pressure, they made sufficiently lock the ball joint in position. Other materials could be aluminum, polystyrene, rubber, steel, Plexiglass, or any other suitable material. These materials could comprise a single, multiple or various combinations of components of a joint. Cavity 403 may pass through the ball and through the coupling in a linear fashion.

In another embodiment, ball 401 and coupling 402 may comprise in part or whole of electro active materials. Alteration of electric current may encourage the deformation of the ball 401 within the coupling 402 or the coupling 402 around the ball 401, resulting in a locked ball joint.

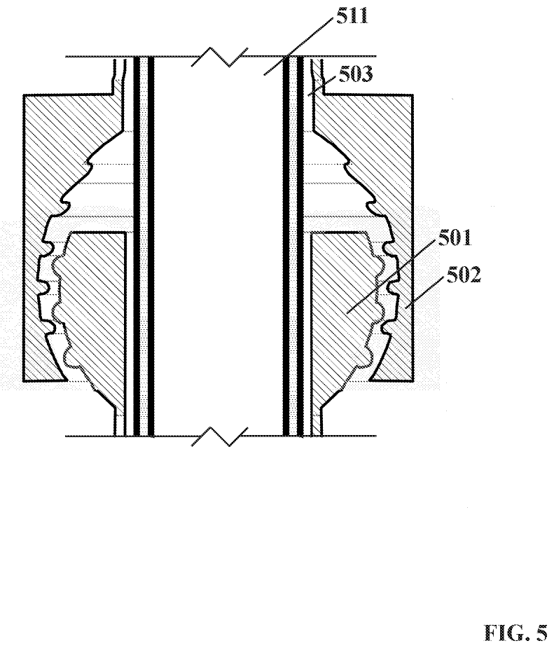

FIG. 5 is a cross sectional view showing the ball 501, located within the coupling 502, with a fluid tube 511, passing through the internal passageway, 503. Fluid tube 511 may expand within ball 501 and coupling 502, and apply pressure to ball 501, expanding ball 501 within coupling 502. Coupling 502 may be more resistive to expansion than ball 501, allowing for ball 501 to press against the interior surface of coupling 502. Fluid tube 511 may comprise of at least one tube of which is air or water tight. Fluid Tube 511 may be additional tubes or sleeves layered around each-other or within each-other.

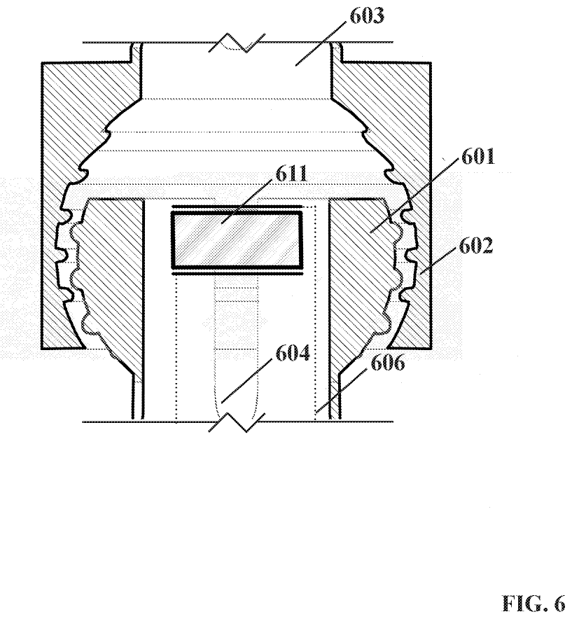

FIG. 6 is a cross sectional view showing the ball 601, located within the coupling 602, with an actuator 611 positioned within the internal passageway, 603. Actuator 611 may expand within ball 601 and coupling 602, and apply pressure to ball 601, expanding ball 601 within coupling 602. Coupling 602 may be more resistive to expansion than ball 601, allowing for ball 601 to press against the interior surface of coupling 602. Ball 601 may have an expansion gap 604 to allow for the ball to expand or contract. Actuator feed wires 606 may be wired through internal passageway 603, or may be wired to the ball 601, or coupling 602 of which may provide electrical current.

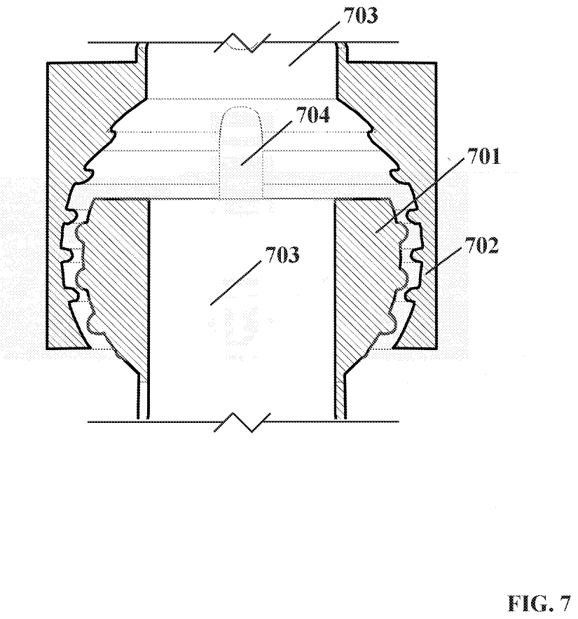

FIG. 7 is a cross sectional view of a locking ball joint with a ball 701, coupling 702 and expansion gap 704. The expansion gap 704 may allow for the Coupling 702 may be less resistive to compression than ball 701, allowing for coupling 702 to press against the surface of ball 701. Ball 701 and coupling 702 may have an internal passageway 703.

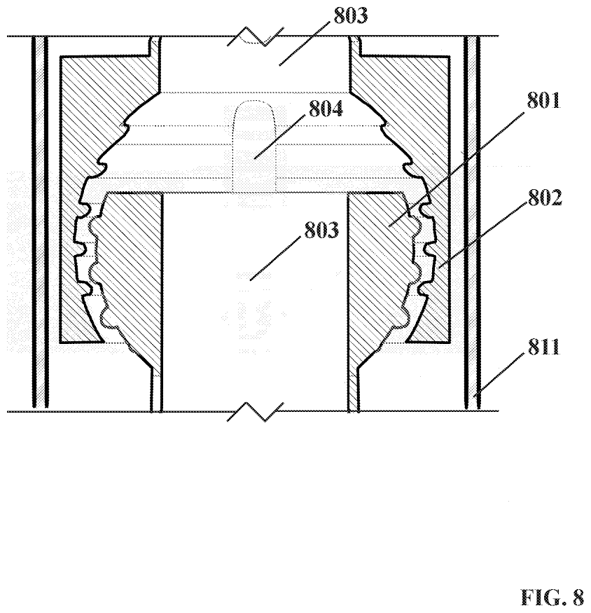

FIG. 8 is a cross sectional view of a locking ball joint with ball 801, coupling 802, expansion gap 804, internal passageway 803 and external sleeve 811. External sleeve 811 may exhibit vacuum or plenum pressure on coupling 802. The pressure may result in coupling 802 contracting around ball 801.

1. A ball joint capable of transition between a rotational and a fixed condition.

2. A ball joint capable of transition between a rotational and a fixed condition without user adjustment at the joint.

3. A ball joint that maintains rotational movement under one pressure exhibited by a fluid tube, and becomes fixed in position under a different pressure exhibited by a fluid tube.

4. The ball joint of claim 1, wherein the condition change is achieved by a change in pressure around the ball joint.

5. The ball joint of claim 1, wherein the condition change is achieved by a change in pressure within the ball joint.

6. The ball joint of claim 1, wherein the condition change is achieved by a state of matter change.

7. The ball joint of claim 1, wherein the condition change is achieved by electroactive composite activation.

8. The ball joint of claim 1, wherein the condition change is achieved by electroactive composite deactivation.

9. The ball joint of claim 2, wherein the condition change is achieved by a change in pressure around the ball joint.

10. The ball joint of claim 2, wherein the condition change is achieved by a change in pressure within the ball joint.

11. The ball joint of claim 2, wherein the condition change is achieved by a state of matter change.

12. The ball joint of claim 2, wherein the condition change is achieved by electroactive composite activation.

13. The ball joint of claim 2, wherein the condition change is achieved by electroactive composite deactivation.

14. The ball joint of claim 3, wherein the rotational movement change is achieved by a change in pressure around the ball joint.

15. The ball joint of claim 3, wherein the rotational movement change is achieved by a change in pressure within the ball joint.

16. The ball joint of claim 3, wherein the rotational movement change is achieved by a state of matter change.

17. The ball joint of claim 3, wherein the rotational movement change is achieved by electroactive composite activation.

18. The ball joint of claim 3, wherein the rotational movement change is achieved by electroactive composite deactivation.
